(19) United States
(12) Patent Application Publication
(10) Pub. No.: US 2009/0244068 A1
(43) Pub. Date: Oct. 1, 2009

(54) SAMPLE ANALYZER AND COMPUTER PROGRAM PRODUCT

(76) Inventor: Yutaka Ikeda, Kakogawa-shi (JP)

Correspondence Address: BRINKS HOFER GILSON & LIONE, P.O. BOX 10395, CHICAGO, IL, 60610, US

(21) Appl. No.: 12/408,127

(22) Filed: Mar. 20, 2009

(30) Foreign Application Priority Data
Mar. 28, 2008 (JP) 2008-088827

(51) Int. Cl. G06T 11/20; G06K 9/62; G06K 9/00

(52) U.S. Cl. 345/440; 382/224; 382/134

(57) ABSTRACT

The present invention is to present a sample analyzer for analyzing a sample containing a plurality of kinds of particles, comprising: a quantization information obtainer for obtaining quantization information representing characteristics of the particles in the sample; a first generator for generating first classification data for classifying the particles in the sample into a plurality of kinds of particles, from the quantization information; a second generator for generating second classification data for classifying the particles in the sample, from the quantization information, the second classification data being different from the first classification data; a memory for storing a classification condition to be used for classifying the particles in the sample; and a classifying part for classifying the particles in the sample, based on the classification condition and one of the first classification data and the second classification data.

### RELATED APPLICATIONS

This application claims priority under 35 U.S.C. §119 to Japanese Patent Application No. JP2008-088827 filed Mar. 28, 2008, the entire content of which is hereby incorporated by reference.

### BACKGROUND

U.S. Patent Publication No. 2007/0111197, for example, discloses a conventional particle sample analyzer for classifying a plurality of types of particles in a sample such as blood and urine and the like.

U.S. Patent Publication No. 2007/0111197 discloses a blood analyzer which pre-stores analysis conditions corresponding to animal species in memory, and reanalyzes a sample by changing the settings to the correct animal type and using the analysis conditions which correspond to the type of animal after the settings have been changed when the sample has been analyzed using incorrect analysis conditions. Specifically, this blood analyzer changes the setting range of the fraction level in accordance with the type of animal in order to fractionate the particles in a particle distribution diagram.

However, analysis programs for setting the fractionation level must be developed in accordance with the number of animal species in order to change the setting range of the fraction level in a particle distribution diagram in accordance with the animal species as in the case of the blood analyzer disclosed in U.S. Patent Publication No. 2007/0111197. A problem thus arises inasmuch as these various programs can only be developed at great cost and time.

### SUMMARY OF THE INVENTION

A first aspect of the present invention is a sample analyzer for analyzing a sample containing a plurality of kinds of particles, comprising: a quantization information obtainer for obtaining quantization information representing characteristics of the particles in the sample; first generating means for generating first classification data for classifying the particles in the sample into a plurality of kinds of particles, from the quantization information obtained by the quantization information obtainer; second generating means for generating second classification data for classifying the particles in the sample into a plurality of kinds of particles, from the quantization information obtained by the quantization information obtainer, the second classification data being different from the first classification data; a memory for storing a classification condition to be used for classifying the particles in the sample into a plurality of kinds of particles; and classifying means for classifying the particles in the sample into a plurality of kinds of particles, based on the classification condition and one of the first classification data and the second classification data.

A second aspect of the present invention is a sample analyzer for analyzing a sample containing a plurality of kinds of particles, comprising: first quantization information obtaining means for obtaining first quantization information representing characteristics of the particles in the sample, the first quantization information being quantized to a predetermined number of bits; second quantization information obtaining means for obtaining second quantization information by expanding or compressing the first quantization information obtained by the first quantization information obtaining means by a predetermined scale factor, the second quantization information being quantized to the predetermined number of bits; a memory for storing a classification condition to be used for classifying the particles in the sample into a plurality of kinds of particles; and classifying means for classifying the particles in the sample into a plurality of kinds of particles based on the classification condition and one of the first quantization information and the second quantization information.

A third aspect of the present invention is a computer program product for enabling a computer to control a sample analyzer for analyzing a sample containing a plurality of kinds of particles, comprising: a computer readable medium, a classification condition, on the computer readable medium, to be used for classifying the particles in the sample into a plurality of kinds of particles, and software instructions, on the computer readable medium, for enabling the computer to perform predetermined operations comprising: controlling the sample analyzer so as to obtain quantization information representing characteristics of the particles in the sample; generating first classification data for classifying the particles in the sample into a plurality of kinds of particles, from the obtained quantization information; generating second classification data for classifying the particles in the sample into a plurality of kinds of particles, from the obtained quantization information, the second classification data being different from the first classification data; and classifying the particles in the sample into a plurality of kinds of particles, based on the classification condition and one of the first classification data and the second classification data.

### BRIEF DESCRIPTION OF THE DRAWINGS

FIG. 1 is a perspective view schematically showing the structure of the first embodiment of the sample analyzer of the present invention;

FIG. 2 is a block diagram showing the structure of the measuring device of the sample analyzer of the first embodiment of the present invention;

FIG. 3 is a block diagram schematically illustrating the structure of the sample preparing section of the first embodiment of the present invention;

FIG. 4 is a block diagram schematically illustrating the structure of the detecting section and the analog processing section of the first embodiment of the present invention;

FIG. 5 is a block diagram showing the structure of the operation and display device of the sample analyzer of the first embodiment of the present invention;

FIG. 6 shows an example of the data structure of the patient information memory device;

FIG. 7 shows an example of a scattergram produced by the leukocyte classification measurement (DIFF measurement);

FIG. 8 shows an example of the relationship between sampling values and lymphocyte distribution region in the scattergram produced by the DIFF measurement;

FIG. 9 is a flow chart showing the CPU processing sequences of the operation and display device and controller of the control board of the measuring device of the first embodiment of the present invention;

FIG. 10 is a flow chart showing the CPU analysis processing sequence of the operation and display device of the first embodiment of the present invention;

FIG. 11 shows an example of a measurement data operation processing result;

FIG. 12 is a flow chart showing the CPU reanalysis processing sequence of the operation and display device of the first embodiment of the present invention;

FIG. 13 is a flow chart showing the CPU processing sequences of the operation and display device and controller of the control board of the measuring device of a second embodiment of the present invention;

FIG. 14 is a flow chart showing the CPU analysis processing sequence of the operation and display device of the second embodiment of the present invention;

FIG. 15 is a flow chart showing the CPU classification data selection processing sequence of the operation and display device of the second embodiment of the present invention; and

FIG. 16 shows an example of a screen for displaying the classification results of the display device of the operation and display device of the second embodiment of the present invention.

### DETAILED DESCRIPTION OF THE PREFERRED EMBODIMENTS

A blood analyzer for analyzing blood is specifically described hereinafter as an example of the sample analyzer of the present embodiment based on the drawings. The analysis process thus is a blood cell classification process, and the analysis data are generated as classification data.

### First Embodiment

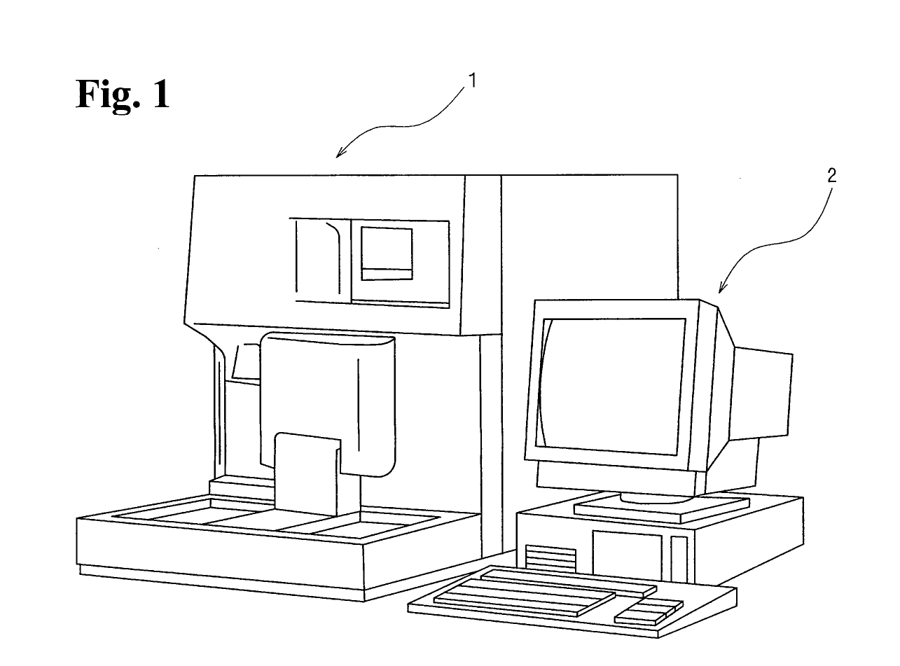

FIG. 1 is a perspective view schematically showing the structure of the first embodiment of the sample analyzer of the present invention; As shown in FIG. 1, the sample analyze of the first embodiment is configured by a measuring device 1, and an operation and display device 2 which is connected to the measuring device 1 so as to be capable of data communication therewith.

The measuring device 1 and the operation and display device 2 are connected via a communication line which is not shown in the drawing. The operation and display device 2 controls the operation of the measuring device 1, processes the measurement data output from the measuring device 1, and obtains analysis results through data communication with the measuring device 1. The measuring device 1 and the operation and display device 2 may also be connected over a network, or may be configured as a single integrated device so as to send and receive data by interprocess communication and the like.

The measuring device 1 detects characteristics information of the leukocytes, reticulocytes, and platelets in the blood using flow cytometry, and transmits the detection data as measurement data to the operation and display device 2. Flow cytometry is a measurement method which forms a sample flow that includes a measurement sample, detects light such as forward scattered light, side scattered light, and side fluorescent light that is emitted by the particles (blood cells) in the measurement sample when the measurement sample is irradiated by laser light to detect the particles (blood cells) in the measurement sample.

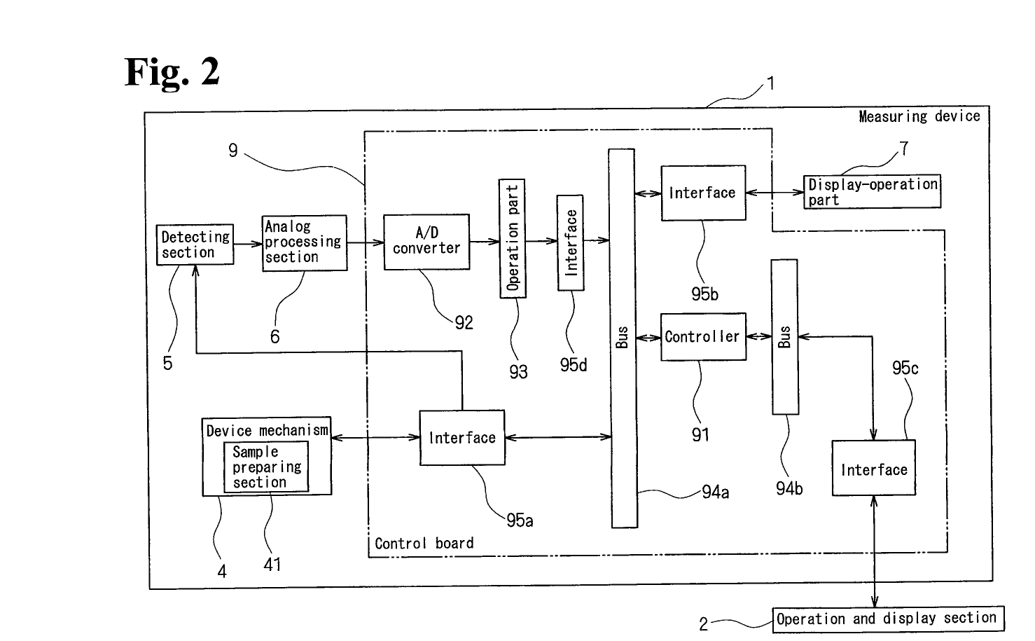

FIG. 2 is a block diagram showing the structure of the measuring device 1 of the sample analyzer of the first embodiment of the present invention. The measuring device 1 is provided with a device mechanism 4, detecting section 5 for executing the measurement of a measurement sample, an analog processing section 6 for processing the output of the detecting section 5, display and operation section 7, and control board 9 for controlling the operation of the various hardware.

The control board 9 is provided with a controller 91 which has a control processor and a memory for the operation of the control processor, twelve-bit A/D converter 92 for converting the signals output from the analog processing section 6 to digital signals, And an operation section 93 for storing the digital signals output from the A/D converter 92 and executing a process for selecting data to be output top the controller 91. The controller 91 is connected to the display and operation section 7 through a bus 94a and an interface 95b, connected to the device mechanism 4 through the bus 94a and an interface 95a, and connected to the operation and display device 2 through a bus 94b and an interface 95c. The operation section 93 outputs the operation results to the controller 91 through an interface 95d and the bus 94a. The controller 91 also transmits the operation results (measurement data) to the operation and display device 2.

The device mechanism 4 is provided with a sample preparing section 41 for preparing a measurement sample from blood and reagent. The sample preparing section 41 prepares leukocyte measurement samples, reticulocyte measurement samples, and platelet measurement samples.

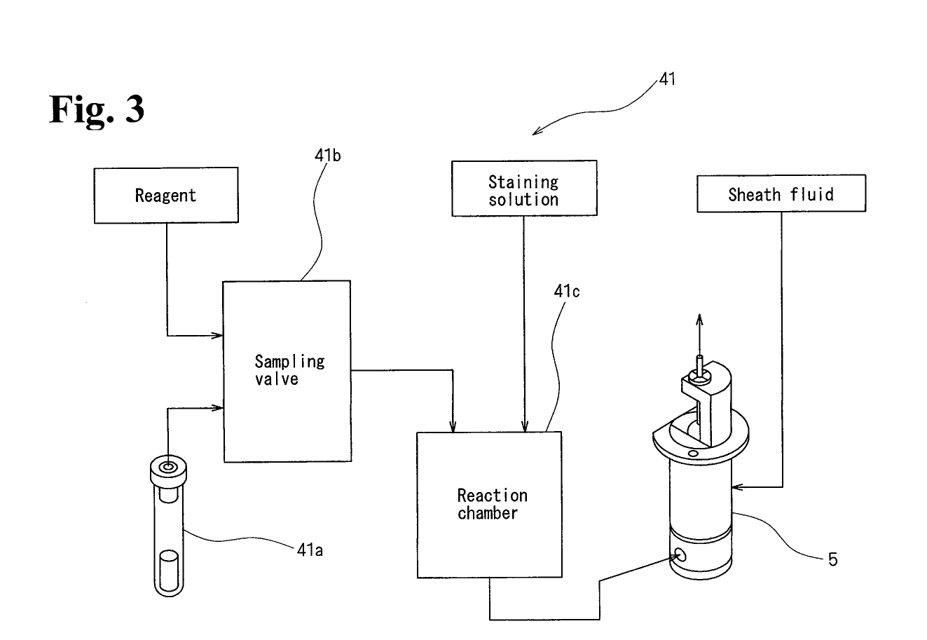

FIG. 3 is a block diagram schematically illustrating the structure of the sample preparing section 41 of the first embodiment of the present invention. The sample preparing section 41 is provided with a collection tube 41a to be filled with a predetermined amount of blood, sampling valve 41b for aspirating the blood, and a reaction chamber 41c.

The sampling valve 41b is configured to be capable of determining the amount of blood within the collection tube 41a aspirated by an aspirating pipette which is not shown in the drawing. The reaction chamber 41c is connected to the sampling valve 41b, and is configured to be capable of mixing a predetermined reagent and staining solution with the fixed amount of blood determined by the sampling valve 41b. The reaction chamber 41c is also connected to the detecting section 5, and is configured so that a measurement sample prepared by mixing the predetermined reagent and staining solution in the reaction chamber 41c inflows to the detecting section 5.

The sample preparing section 41 can thus prepare a measurement sample in which the leukocytes are stained and the erythrocytes are hemolyzed as the leukocyte measurement sample. The sample preparing section 41 can also prepare a measurement sample in which the reticulocytes are stained as a reticulocyte measurement sample, and prepare a measurement sample in which the platelets are stained as a platelet measurement sample. The prepared measurement sample is supplied together with a sheath fluid to a sheath flow cell of the detecting section 5 which will be described later.

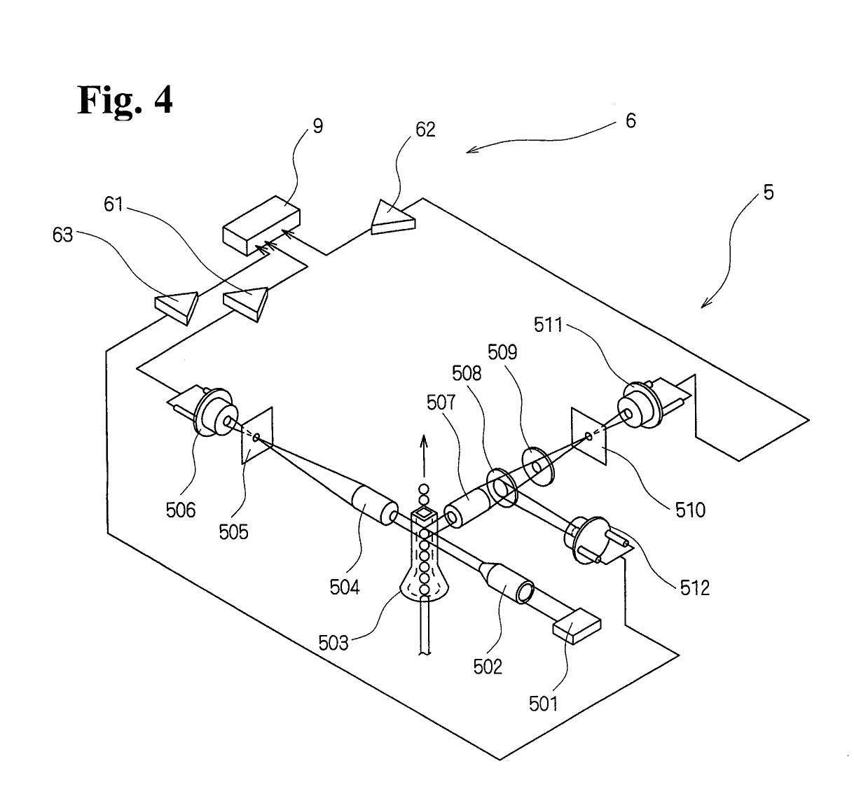

FIG. 4 is a block diagram schematically showing the structure of the detecting section 5 and the analog processing section 6 of the first embodiment of the present invention. As shown in FIG. 4, the detecting section 5 is provided with a light-emitting part 501 for emitting laser light, irradiating lens unit 502, sheath flow cell 503 for irradiating by laser light, collective lens 504 disposed on a line extending in the direction of advancement of the light from the light-emitting part 50, pinhole 505 and PD (photodiode) 506 (a beam stopper which is not shown in the drawing is disposed between the sheath flow cell 503 and the collective lens 504), collective lens 507 which is disposed in a direction which intersects the direction of the light emitted from the light-emitting part 501, dichroic mirror 508, optical filter 509, pinhole 510 and APD (avalanche photodiode) 511, and PD (photodiode) 512 which is disposed on the dichroic mirror 508 side.

The light-emitting part 501 is provided to irradiate light on a sample flow which contains a measurement sample passing through the interior of the sheath flow cell 503. The irradiating lens unit 502 is provided to render the light emitted from the light-emitting part 501 into parallel rays. The PD 506 is provided to receive the forward scattered light emitted from the sheath flow cell 503 Note that information relating to the size of the particles (blood cells) in the measurement sample can be obtained from the forward scattered light emitted from the sheath flow cell 503.

The dichroic mirror 508 is provided to separate the side scattered light and the side fluorescent light emitted from the sheath flow cell 503. Specifically, the dichroic mirror 508 is provided to direct the side scattered light emitted from the sheath flow cell 503 to the PD 512, and to direct the side fluorescent light emitted from the sheath flow cell 503 to the APD 511. The PD 512 is also provided to receive the side scattered light. Internal information relating to the size and the like of the nucleus of the particles (blood cells) within the measurement sample can be obtained from the side scattered light emitted from the sheath flow cell 503.

The APD 511 is also provided to receive the side fluorescent light. When light irradiates a fluorescent substance such as a stained blood cell, light is emitted which has a longer wavelength that that of the irradiating light. The intensity of the fluorescence increases as the degree of staining increases. Therefore, characteristic information related to the degree of staining of the blood cell can be obtained by measuring the intensity of the side fluorescent light emitted from the sheath flow cell 503. It is therefore possible to perform other measurements in addition to classifying leukocytes by the difference in the side fluorescent light intensity. PD 506, PD 512, and APD 511 convert the optical signals of the respectively received light to electrical signals, and the converted electrical signals are then amplified by amplifiers 61, 62, and 63 and the amplified signals are transmitted to the control board 9.

In the first embodiment, the light-emitting part 501 emits light with an output of 3.4 mW during the leukocyte classification measurement (hereinafter referred to as “DIFF measurement”). The light-emitting part 501 also emits light with an output of 6 mW during the reticulocyte measurement (hereinafter referred to as “RET measurement”). The light-emitting part also emits light at an output of 10 mW during platelet measurement (hereinafter referred to as “PLT measurement”).

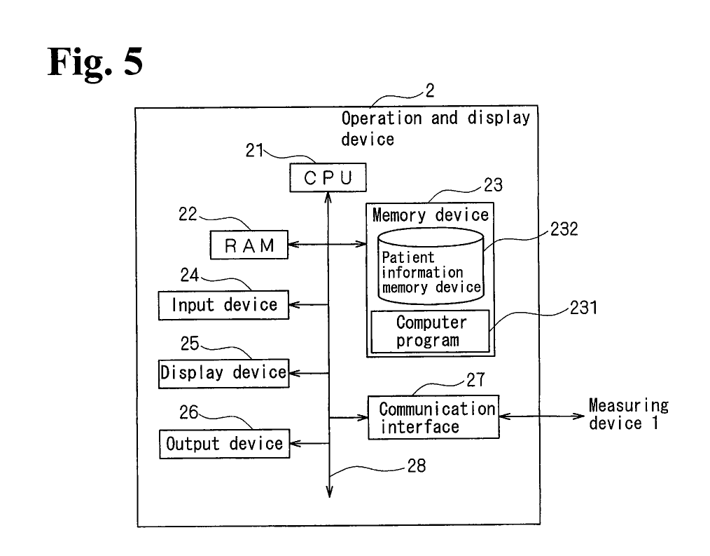

FIG. 5 is a block diagram showing the structure of the operation and display device 2 of the sample analyzer of the first embodiment of the present invention. As shown in FIG. 5, the operation and display device 2 is configured by a CPU (central processing unit) 21, RAM 22, memory device 23, input device 24, display device 25, output device 26, communication interface 27, and an internal bus 28 which is connected to the previously described hardware. The CPU 21 is connected to each piece of previously mentioned hardware of the operation and display device 2 through the internal bus 28, and controls the operation of the aforesaid hardware and executes various software functions according to a computer program 231 which is stored in the memory device 23. RAM 22 is configured of a volatile memory such as an SRAM, SDRAM or the like, and stores load modules during the execution of the computer program 231 as well as temporary data generated during the execution of the computer program 231.

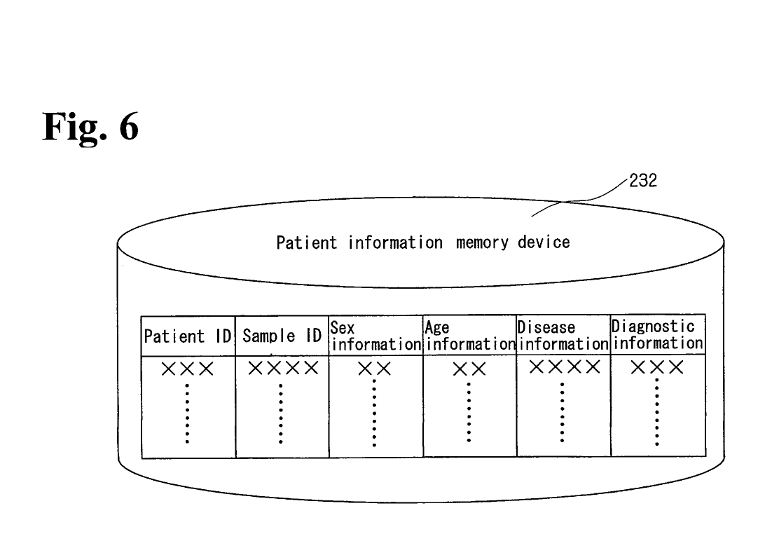

The memory device 23 is configured by an internal fixed type memory device (hard disk) or the like. The memory device 23 is also provided with a patient information memory device 232 which stores information relating to patients and including the age information of the patient (subject) associated with identification information which can be obtained by reading a barcode label. FIG. 6 shows an example of the data structure of the patient information memory device 232. As shown in FIG. 6, the patient information memory device 232 stores subject ID which is the identification information that identifies the subject, sex information of the subject, age information of the subject, disease information relating the content of the disease, and treatment information which identifies the treatment, and all of which is associated with a sample ID which is which is the identification information obtained by reading a barcode label. Note that the patient information memory device 232 is not limited to being provided in the memory device 23 insofar as the patient information may also be prestored on an external computer and obtained by querying the external computer through the communication interface 27.

The communication interface 27 is connected to the internal bus 28, and is capable of sending and receiving data when connected to the measuring device 1 through a communication line. That is, the communication interface 27 sends information instructing the start of a measurement and the like to the measuring device 1, and receives measurement data.

The input device 24 is a data input medium such as a keyboard and mouse or the like. The display device 25 is a display device such as a CRT monitor, LCD or the like, and graphically displays the analysis results. The output device 26 is a printing device such as a laser printer, inkjet printer or the like.

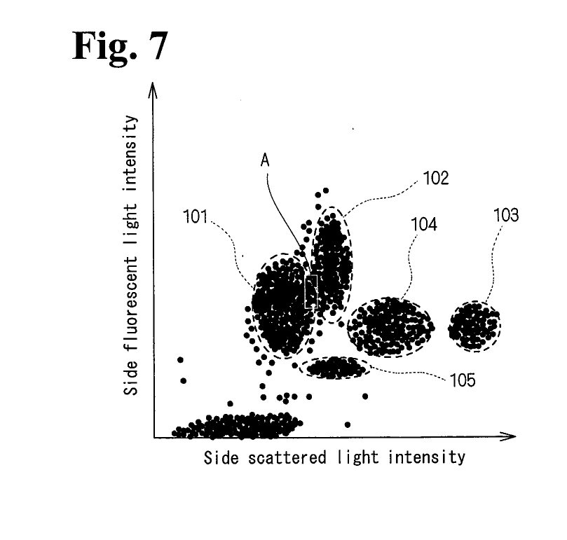

In the measuring device 1 and operation and display device 2 of the sample analyzer having the structure described above, a scattergram such as that shown in FIG. 7 is prepared and displayed on the display device 25 when adult blood is measured and the leukocytes contained in the blood have been classified as lymphocytes, monocytes, neutrophils, basophils, and eosinophils. FIG. 7 shows an example of a scattergram produced by the leukocyte classification measurement (DIFF measurement). In FIG. 7, the vertical axis represents the side fluorescent light intensity, and the horizontal axis represents the side scattered light intensity, respectively. The method of classifying leukocytes used by the sample analyzer of the first embodiment is described below.

In the sample analyzer of the first embodiment, a lymphocyte distribution region 101 in which lymphocytes are assumed to be distributed, a monocyte distribution region 102 in which monocytes are assumed to be distributed, an eosinphil distribution region 103 in which eosinophils are assumed to be distributed, a neutrophil distribution region 104 in which neutrophils are assumed to be distributed, and a basophil distribution region in which basophils are assumed to be distributed are predetermined based on previous statistical values of adult blood, as shown in FIG. 7. After integer sequence information has been sampled based on the measurement data, the degree of belonging of blood cells to each distribution region is then calculated for the lymphocyte distribution region 101, monocyte distribution region 102, eosinophil distribution region 103, neutrophil distribution region 104, and basophil distribution region 105, and each blood cell is classified into a specific type of blood cell according to the calculated degree of belonging. The numbers of lymphocytes, monocytes and the like can then be determined by counting the classified blood cells. This leukocyte classification method is described in detail in U.S. Pat. No. 5,555,196. Note that the computer program for executing this leukocyte classification method, and the data used in the execution of this computer program are prestored in the memory device 23.

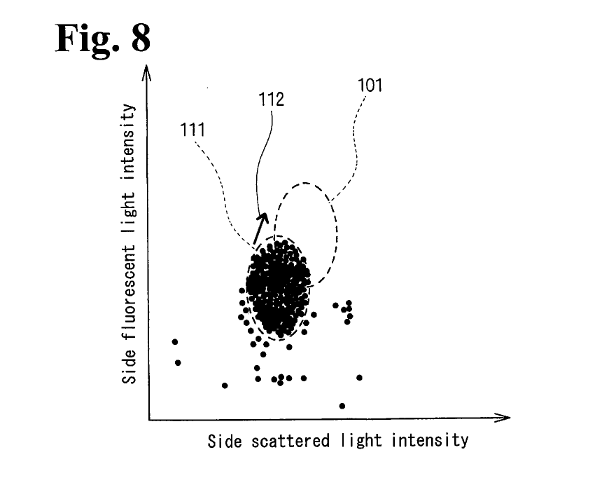

The present inventors acknowledge that the blood cells contained in child blood have lower stainability than blood cell contained in adult blood. It is therefore clear that the sampling values will be distributed somewhat lower in each region of the original distributions shown in FIG. 7 in measurement data obtained by measuring child blood. FIG. 8 shows an example of the relationship between sampling values and the lymphocyte distribution region 101 of a scattergram prepared for a DIFF measurement.

As shown in FIG. 8, the sampling values are clustered on the margin of the lymphocyte distribution region 101 in the case of measurement data of adult blood. However, when the measurement data are for a child blood rather than adult blood, both the fluorescent light intensity and the scattered light intensity are lower values when measured since the child blood has a lower stainability than does adult blood. The sampling values therefore cluster near the edge of the region 111 which is below the lymphocyte distribution region 101.

When the distribution trend from the scattergram is entirely shifted below the assumed region as described above, the measurement data can be determined to be data from child blood, and it can be understood that the region 111 in which the sampling values cluster must be shifted in the direction of the arrow 112 to improve the accuracy of the classification process. A means is disclosed below for shifting the measurement data of child blood in order to realize a classification process which has better accuracy using the same blood cell classification method as when classifying leukocytes based on adult blood, even when the measurement data are data from child blood.

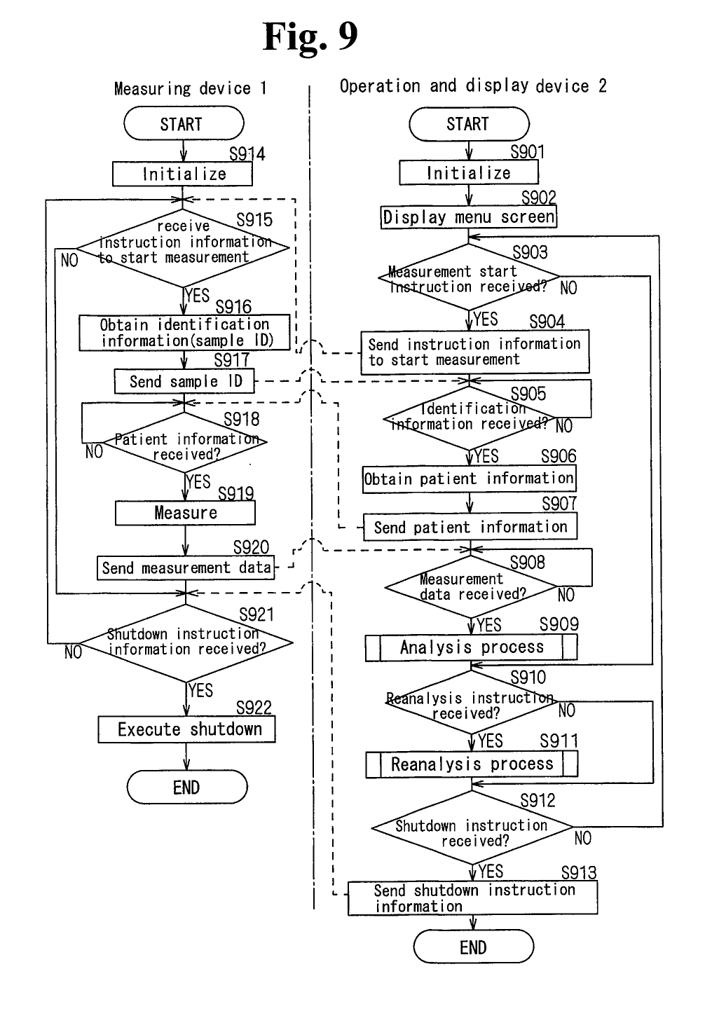

FIG. 9 is a flow chart showing the processing sequence of the CPU 21 of the operation and display device 2 and the controller 91 of the control board 9 of the measuring device 1 of the first embodiment of the present invention. The controller 91 of the measuring device 1 executes initialization (step S914) and an operations check of the each part of the measuring device 1 when the starting of the measuring device 1 is detected. The CPU 21 of the operation and display device 2 also executes initialization (program initialization) (step S901), and displays a menu screen on the display device 25 (step S902) when the starting of the operation and display device 2 is detected. The selection of the DIFF measurement, RET measurement, and CBC measurement (complete blood cell count measurement)can be input, and the measurement start instruction, and shutdown instruction and the like can be input from the menu screen. The case wherein the DIFF measurement has been selected on the menu screen in the first embodiment is described below.

The CPU 21 of the operation and display device 2 determines whether or not a measurement start instruction has been received (step S903); when the determination of the CPU 21 is that a measurement start instruction has not been received (step S903: NO), the CPU 21 skips the subsequent steps S904 through S909. When the CPU 21 has determined that a measurement start instruction has been received (step S903: YES), the CPU 21 transmits instruction information specifying to start a measurement to the measuring device 1 (step S904). The controller 91 of the measuring device 1 determines whether or not instruction information specifying to start a measurement has been received (step S915); when the controller 91 has determined that a instruction information specifying to start a measurement has been received (step S915: YES), the controller 91 has the barcode reader (not shown in the drawing) read the barcode label (not shown in the drawing) adhered to the container which contains the blood to obtain the blood identification information (sample ID) (step S916). When the controller 91 has determined that instruction information specifying to start a measurement has not been received (step S915: NO), the controller 91 skips steps 916 through S920.

The controller 91 transmits the obtained identification information (sample ID) to the operation and display device 2 (step S917), and the CPU 21 of the operation and display device 2 determines whether or not the identification information (sample ID) has been received (step S905). When the CPU 21 determines that the identification information (sample ID) has not been received (step S905: NO), the CPU 21 enters a reception standby state. When the CPU 21 determines that the identification information (sample ID) has been received (step S905: YES), the CPU 21 obtains the patient information by querying the patient information memory device 232 of the memory device 23 (step S906), and transmits the patient information to the measuring device 1 (step S907).

The controller 91 of the measuring device 1 then determines whether or not the patient information has been received (step S918); when the controller 91 determines that the patient information has not been received (step S918: NO), the controller 91 enters a reception standby state. When the controller determines that the patient information has been received (step S918: YES), the controller 91 controls the sample preparing section 41 so as to prepare a measurement sample, and thereafter starts the measurement of a measurement sample (step S919). Specifically, the DIFF measurement is executed, and the electrical signals corresponding to the intensity of the received side scattered light and side fluorescent light are transmitted to the control board 9 via the detecting section 5 and the analog processing section 6. The A/D converter 92 of the control board 9 converts the obtained analog signals to 12-bit digital signals, and the operation section 93 subjects the digital signals output from the A/D converter 92 to predetermined processing, and transmits the signals to the controller 91. The controller 91 transmits the received 12-bit integer sequence information as measurement data to the operation and display device 2 (step S920).

The CPU 21 of the operation and display device 2 determines whether or not the measurement data have been received (step S908); when the CPU 21 determines that the measurement data have been received (step S908: YES), the CPU 21 executes an analysis process based on the received measurement data (step S909). When the CPU 21 determines that the measurement data have not been received (step S908: NO), the CPU 21 enters a reception standby state.

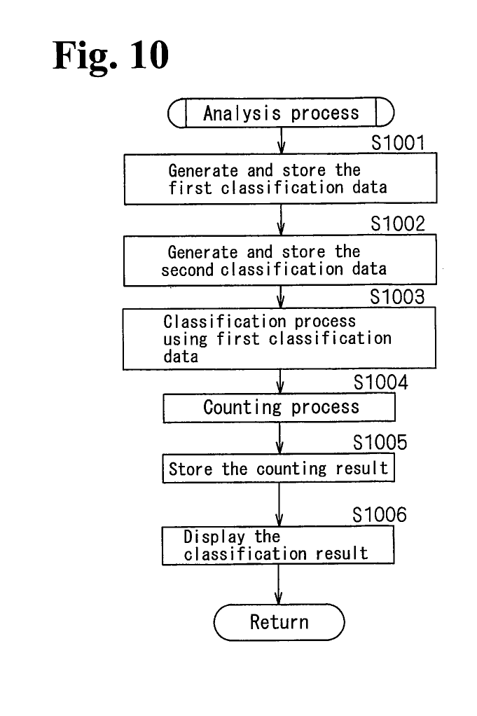

FIG. 10 is a flow chart showing the sequence of the analysis process executed in step S909 of FIG. 9 by the CPU 21 of the operation and display device 2 of the first embodiment of the present invention. In FIG. 10, the CPU 21 of the operation and display device 2 generates a first classification data by compressing the measurement data (12-bit integer sequence information) obtained from the measuring device 1 to 8-bit integer sequence information and stores the first classification data in the memory device 23 (step S1001), and generates a second classification data which is 8-bit integer sequence information with data values that are larger than the data values of the first classification data generated in step S1001 and stores the second classification data in the memory device 23 (step S1002). The first classification data are data which are used when analysis is based on adult blood, and the second classification data are data which are used when analysis is performed based on child blood. That is, the obtained integer sequence information of the child blood must be slightly elevated in order to classify the blood cells within the blood using the same blood cell classification method as adult blood because child blood cells have a lower stainability than does adult blood.

Specifically, the CPU 21 compresses the 12-bit integer sequence information obtained from the measuring device 1 directly to 8-bit integer sequence data when generating the first classification data, and after multiplying the 12-bit integer sequence information 1.2 times, then compresses the integer part to 8-bit integer sequence data when generating the second classification data. By multiplying the 12-bit integer sequence information 1.2 times and thereafter compressing the 8-bit data to generate the second classification data for child blood in this way, a proportion which maintains the continuity of the integer sequence values can be increased compared to when the first classification data of adult blood is simply multiplied 1.2 times to generate the second classification data.

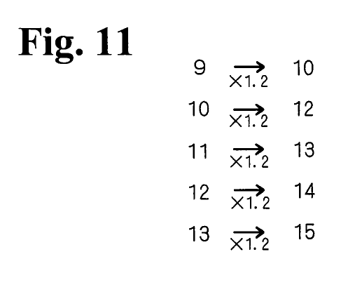

FIG. 11 shows an example of a measurement data operation processing result. That is, when the measurement data are integer values which are consecutively 9 through 13, “11” is deleted when these integer values are simply multiplied 1.2 times, so that the values are no longer consecutive integer values, as shown in FIG. 11. Thus, there is concern that an accurate count result cannot be obtained when classifying a plurality of types of particles.

In the first embodiment, the measurement data is obtained as integer sequence information which has a larger number of bits (12-bits) than the number of bits (8-bits) used in the classification process, and the measurement data are multiplied 1.2 times to generate a second classification data of child blood by compressing the integer part of the multiplied data to 8-bit integer sequence information. The classification process is then executed on the generated second classification data. A proportion which maintains the continuity of the integer values can be increased thereby. That is, since the 12-bit integer sequence information is multiplied 1.2/16 times when generating the second classification data for child blood compared to multiplying the 12-bit integer sequence information 1/16 times when generating the first classification data for adult blood, the range of the measurement data which are the same integer values when multiplied 1.2/16 times is broadened, thus making errors difficult to occur.

For example, consider the case when the number of each element (X1, X2) (where X1, X2=0, 1, 2. . . ) is designated F in two-dimensional distribution data DN which has N×N (N being a natural number) individual elements, and the two-dimensional distribution data Dn are compressed to two-dimensional distribution data Dm which has M×M (M being a natural number) individual elements. Furthermore, M<N obtains.

Each element (X1, X2) in the two-dimensional distribution data which has N×N individual elements corresponds to the elements (U1, U2) (where U1, U2=0, 1, 2, . . . ) shown in equation (1) in the distribution data Dm. In equation (1), Int(x) is a function which represents the integer part of the argument x. This is equivalent, for example, to the process of compressing 12-bit measurement data to 8-bits.

(U1, U2)=(Int(X1(M/N), Int(X2(M/N) (1)

Next, when the two-dimensional distribution data DL which has L(L individual elements in a partial region within the two-dimensional distribution data Dm are converted to two-dimensional distribution data which has M(M individual elements (L<M<N), the elements (X1, X2) (where X1, X2=0, 1, 2, . . . , N(L/M) in the distribution data Dn corresponds to the elements (V1, V2) (where V1, V2=0, 1, 2, . . . , M) in the distribution data Dml, as shown in equation (2). This is equivalent to a process which shifts up the 8-bit data.

(V1, V2)=(Int(X1(M2/(N(L), Int(X2(M2/(N(L) (2)

That is, the number of elements of the distribution data Dml can be calculated and converted to smooth distribution data by initially converting (expanding) the two-dimensional distribution data DL which have an L(L element partial region to two-dimensional distribution data which have N(N elements, and then converting to two-dimensional distribution data which have M(M elements.

Returning to FIG. 10, the CPU 21 of the operation and display device 2 executes the leukocyte classification process based on the generated first classification data (step S1003), counts the number of classified lymphocytes, monocytes, eosinophils, neutrophils, and basophils (step S1004), and stores the count results in the memory device 23 (step S1005). The CPU 21 also generates a scattergram such as that shown in FIG. 7, displays the count results and the scattergram on the display device 25 as leukocyte classification results (step S1006), and the process returns to step S910 of FIG. 9. The user can visually confirm the scattergram displayed on the display device 25, for example by confirming whether or not the sampling values are distributed below the pre-assumed distribution region. When the sampling values are distributed below the pre-assumed distribution region, the user then determines that an analysis failure has occurred because the analyzed blood is child blood, and inputs an execution instruction to execute a reanalysis process based on child blood.

Returning to FIG. 9, the CPU 21 of the operation and display device 2 determines whether or not a reanalysis execution instruction has been received from the user (step S910); when a reanalysis execution instruction has been received (step S910: YES), the CPU 21 executes the reanalysis process (step S911). Specifically, a “reanalysis” button is provided on the toolbar of the screen which displays the classification results on the display device 25, and the CPU 21 receives the reanalysis instruction when the “reanalysis” button is selected by the user.

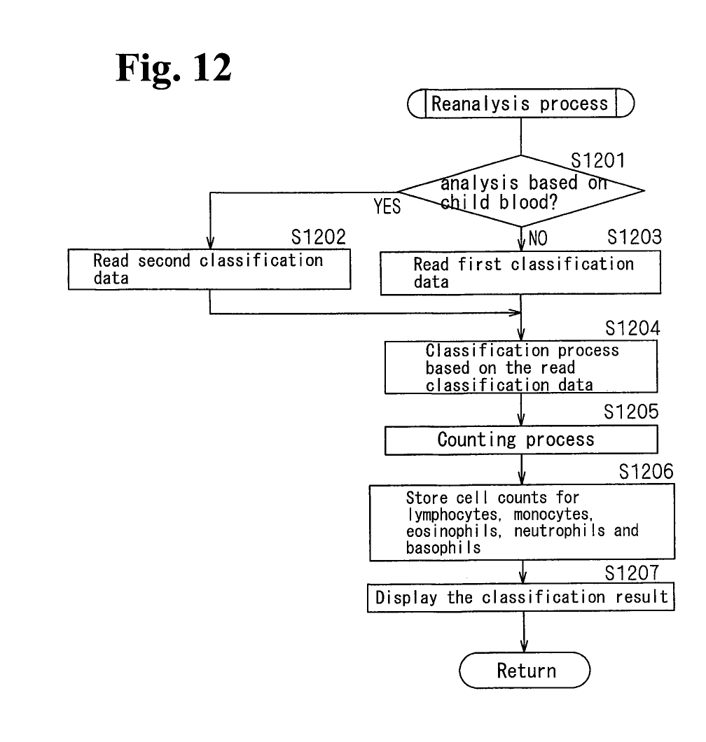

FIG. 12 is a flow chart showing the sequence of the reanalysis process executed in step S911 of FIG. 9 by the CPU 21 of the operation and display device 2 of the first embodiment of the present invention. In FIG. 12, the CPU 21 of the operation and display device 2 determines whether or not to execute the reanalysis based on child blood (step S1201). In the operation and display device 2, not only can a reanalysis instruction be issued to reanalyze classification results obtained based on adult blood to obtain classification results based on child blood, a reanalysis instruction can also be issued to reanalyze classification results obtained based on child blood to obtain classification results based on adult blood. Thus, the CPU 21 reads the second classification data from the memory device 23 (step S1202) when the CPU 21 determines whether or not to execute reanalysis based on child blood in step S1201, that is, determines whether or not a reanalysis instruction specifying reanalysis of classification results obtained based on adult blood so as to obtain classification results based on child blood has been received from the user and the CPU 21 has determined to execute reanalysis based on child blood (step S1201: YES).

When the CPU 21 has determined to not execute reanalysis based on child blood (step S1201: NO), the CPU 21 reads the first classification data from the memory device 23 (step S1203). The CPU 21 executes the classification process based on the read first classification data or second classification data (step S1204), and counts the numbers of classified lymphocytes, monocytes, eosinophils, neutrophils, and basophils. The CPU 21 stores the count results in the memory device 23 (step S1206), displays the classification results on the display device 25 (step S1207), and the process returns to step S912.

Returning to FIG. 9, the CPU 21 of the operation and display device 2 determines whether or not a shutdown instruction has been received (step S912); when the CPU 21 has determined that a shutdown instruction has not been received (step S912: NO), the CPU 21 returns the process to step S903, and the previously described process is repeated. When the CPU 21 has determined that a shutdown instruction has been received (step S912: YES), the CPU 21 transmits shutdown instruction information to the measuring device 1 (step S913).

The controller 91 of the measuring device 1 determines whether or not shutdown instruction information has been received (step S921); when the controller 91 has determined that shutdown instruction information has not been received (step S921: NO), the controller 91 returns the process to step S915 and the previously described process is repeated. When the controller 91 has determined that shutdown instruction information has been received (step S921: YES), the controller 91 executes shutdown (step S922) and the process ends.

The first embodiment described above is capable of performing analysis using a common analysis program even in the case of differences such as different animal species, different ages and different sex, therefore it is possible to save the excessive cost and time required to develop various analysis programs.

Note that although the first classification data for adult blood and the second classification data for child blood are generated and stored in the memory device 23 before a reanalysis instruction is issued by a user in the above first embodiment, the second classification data for child blood may not be generated until the moment the user issues an instruction for reanalysis based on child blood. In this case, the operation processing load on the device can be reduced since the second classification data are only generated when specified.

### Second Embodiment

The sample analyzer of a second embodiment of the present invention is described in detail below based on the drawings. Structures of the sample analyzer of the second embodiment of the present invention which are identical to the first embodiment are designated by like reference numbers and detailed description thereof is omitted. The second embodiment differs from the first embodiment in that a plurality of classification data having mutually different compression ratios and classification results based on these respective classification data are prestored in the memory device 23, and classification results based on the selection of any of these classification data are displayed.

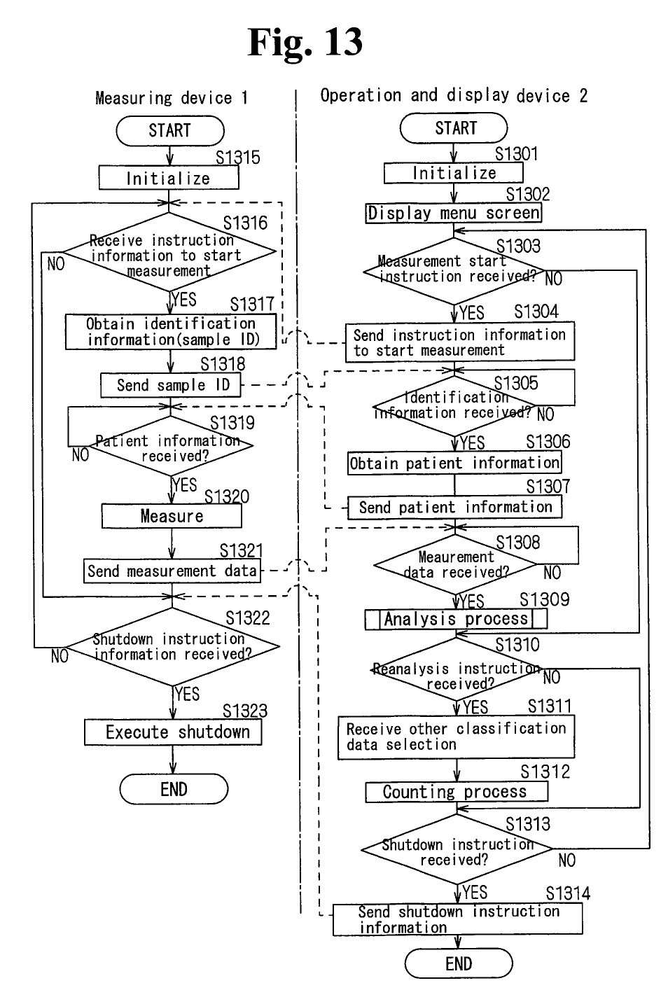

FIG. 13 is a flow chart showing the processing sequence of the CPU 21 of the operation and display device 2 and the controller 91 of the control board 9 of the measuring device 1 of the second embodiment of the present invention. The controller 91 of the measuring device 1 executes initialization (step S1315) and an operations check of the each part of the measuring device 1 when the starting of the measuring device 1 is detected. The CPU 21 of the operation and display device 2 also executes initialization (program initialization) (step S1301), and displays a menu screen on the display device 25 (step S1302) when the starting of the operation and display device 2 is detected. The selection of the DIFF measurement, RET measurement, and CBC measurement can be input, and the measurement start instruction, and shutdown instruction and the like can be input from the menu screen. The case wherein the DIFF measurement has been selected on the menu screen in the second embodiment is described below.

The CPU 21 of the operation and display device 2 determines whether or not a measurement start instruction has been received (step S1303); when the determination of the CPU 21 is that a measurement start instruction has not been received (step S1303: NO), the CPU 21 skips the subsequent steps S1304 through S1309. When the CPU 21 has determined that a measurement start instruction has been received (step S1303: YES), the CPU 21 transmits instruction information specifying to start a measurement to the measuring device 1 (step S1304). The controller 91 of the measuring device 1 determines whether or not instruction information specifying to start a measurement has been received (step S1316); when the controller 91 has determined that a instruction information specifying to start a measurement has been received (step S1316: YES), the controller 91 has the barcode reader (not shown in the drawing) read the barcode label (not shown in the drawing) adhered to the container which contains the blood to obtain the blood identification information (sample ID) (step S1317). When the controller 91 has determined that instruction information specifying to start a measurement has not been received (step S1316: NO), the controller 91 skips steps 1317 through S1321.

The controller 91 transmits the obtained identification information (sample ID) to the operation and display device 2 (step S1318), and the CPU 21 of the operation and display device 2 determines whether or not the identification information (sample ID) has been received (step S1305). When the CPU 21 determines that the identification information (sample ID) has not been received (step S1305: NO), the CPU 21 enters a reception standby state. When the CPU 21 determines that the identification information (sample ID) has been received (step S1305: YES), the CPU 21 obtains the patient information by querying the patient information memory device 232 of the memory device 23 (step S1306), and transmits the patient information to the measuring device 1 (step S1307).

The controller 91 of the measuring device 1 then determines whether or not the patient information has been received (step S1319); when the controller 91 determines that the patient information has not been received (step S1319: NO), the controller 91 enters a reception standby state. When the controller determines that the patient information has been received (step S1319: YES), the controller 91 controls the sample preparing section 41 so as to prepare a measurement sample, and thereafter starts the measurement of a measurement sample (step S1320). Specifically, the DIFF measurement is executed, and the electrical signals corresponding to the intensity of the received side scattered light and side fluorescent light are transmitted to the control board 9 via the detecting section 5 and the analog processing section 6. The A/D converter 92 of the control board 9 converts the obtained analog signals to 12-bit digital signals, and the operation section 93 subjects the digital signals output from the A/D converter 92 to predetermined processing, and transmits the signals to the controller 91. The controller 91 transmits the received 12-bit integer sequence information as measurement data to the operation and display device 2 (step S1321).

The CPU 21 of the operation and display device 2 determines whether or not the measurement data have been received (step S1308); when the CPU 21 determines that the measurement data have been received (step S1308: YES), the CPU 21 executes an analysis process based on the received measurement data (step S1309). When the CPU 21 determines that the measurement data have not been received (step S1308: NO), the CPU 21 enters a reception standby state.

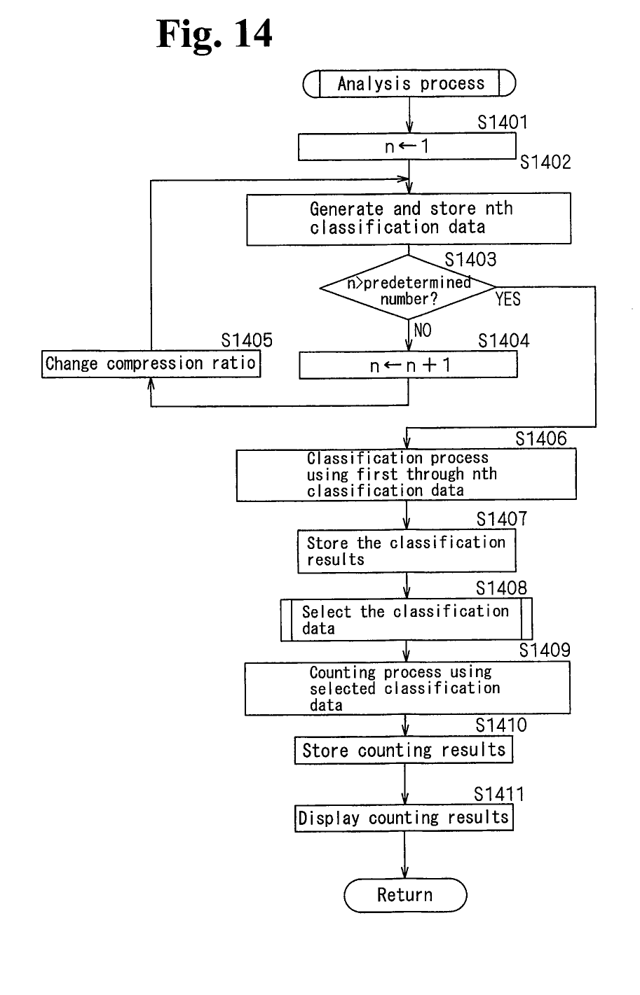

FIG. 14 is a flow chart showing the sequence of the analysis process executed in step S1309 of FIG. 13 by the CPU 21 of the operation and display device 2 of the second embodiment of the present invention. In FIG. 14, the CPU 21 of the operation and display device 2 sets the counter n to an initial value 1 (step S1401), generates nth classification data by compressing the measurement data (12-bit integer sequence information) obtained from the measuring device 1 to 8-bit integer sequence information, and stores this data in the memory device 23 (step S1402).

The CPU 21 determines whether or not n is greater than a predetermined number (step S1403); when the CPU 21 has determined that n is less than the predetermined number (step S1403: NO), the CPU 21 increments n by 1 (step S1404), changes the compression ratio of the measurement data (step S1405), and returns the process to step S1402 whereupon the above process is repeated. When the CPU 21 has determined that n is greater than the predetermined number (step S1403: YES), the CPU 21 executes the classification process using the respective first through nth classification data (step S1406), and stores the respective classification results in the memory device 23 (step S1407).

Specifically, when the CPU generates the classification data, the 12-bit integer sequence information obtained from the measurement device 1 is compressed by a predetermined compression ratio. For example, the information may be compressed to 8-bit integer sequence information, compressed to 10-bit integer sequence information, or an optional compression ratio may be selected.

In the second embodiment, measurement data are pre-obtained as integer sequence information which has a number of bits (12-bits) that is greater the number of bits (8-bits) used as classification data, and a plurality of classification data at various compression ratios are generated by compressing the pre-obtained measurement data by an optional compression ratio. A proportion which maintains the continuity of the integer sequence values can be increased thereby. For example, since the 12-bit integer sequence information is multiplied 1.2/16 times when generating the second classification data for child blood compared to multiplying the 12-bit integer sequence information 1/16 times when generating the first classification data for adult blood, the range of the measurement data which are the same integer values when multiplied 1.2/16 times is broadened, thus making errors difficult to occur.

The CPU 21 selects one classification data from the plurality of classification data stored in the memory device 23 (step S1408), reads the selected classification data from the memory device 23, counts the numbers of lymphocytes, monocytes, eosinophils, neutrophils, and basophils and the like (step S1409), and stores the count results in the memory device 23 (step 1410). The CPU 21 also generates a scattergram such as that shown in FIG. 7, displays the count results and the scattergram on the display device 25 as leukocyte classification results (step S1411), and the process returns to step S1310 of FIG. 13. The user can visually confirm the scattergram displayed on the display device 25. Then the user can input execution instructions for executing a reclassification process according to the distribution conditions of the sampling values.

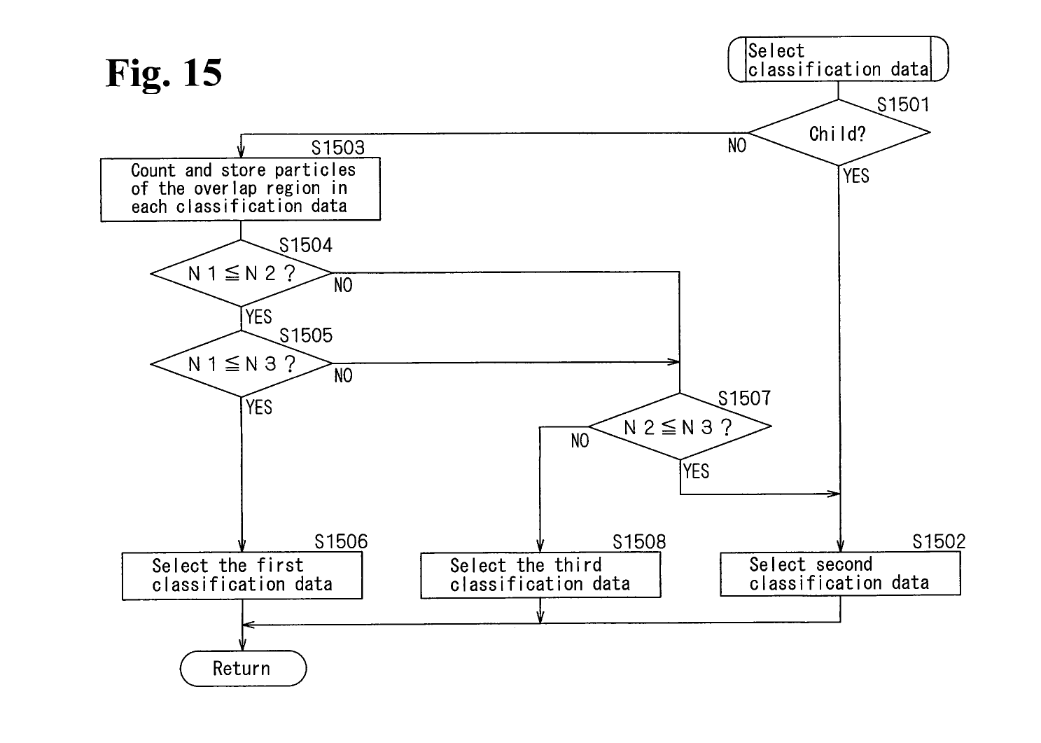

The sequence of the classification data selection process shown in step S1408 of FIG. 18 is described below. FIG. 15 is a flow chart showing the sequence of the classification data selection process performed by the CPU 21 of the operation and display device 2 of the second embodiment of the present invention. Note that in the sample analyzer of the second embodiment, the predetermined number shown in FIG. 14 is set at 3.

The CPU 21 of the operation processing device 2 determines whether or not a subject is an child based on the age information included in the patient information received from the measuring device 1 (step S1501). “Child” in this case may mean a newborn, infant, or toddler. The user of the sample analyzer of the second embodiment of the present invention may optionally set the sample analyzer, for example, so that a subject admitted to a pediatric department or obstetrics and gynecology department is designated as a “child,” or a child who is a preschooler may be designated as a “child,” rather than a subject below a predetermined age. The manufacturer who fabricates the sample analyzer may also set the range of the “child.” When the CPU 21 has determined that the subject is a child (step S1501: YES), the CPU 21 selects the second classification data generated at the compression ratio for child blood (step S1502), and the process returns to step S1409.

When the CPU 21 has determined that the subject is not a child (step S1501: NO), the CPU 21 counts the particles contained in a region in which there are overlapping collection region of sampling values of the lymphocytes, monocytes, eosinophils, neutrophils, basophils and the like, for example region A in FIG. 7 (hereinafter referred to as “overlap region”), among the first through third distribution data, and stores the counts in the RAM 22 (step S1503). The CPU 21 selects the distribution data which has an overlap region with the least number of particles since the blood cell classification process should perform well when the overlap region has few particles. That is, the CPU 21 first determines whether or not the particle number (N1) of the overlap region in the first classification data is less than the particle number (N2) of the overlap region in the second classification data (step S1504).

When the CPU 21 has determined that the particle number (N1) of the overlap region in the first classification data is less than the particle number (N2) of the overlap region in the second classification data (step S1504: YES), the CPU 21 then the CPU 21 determines whether or not the particle number (N1) of the overlap region in the first classification data is less than the particle number (N3) of the overlap region in the third classification data (step S1505).

When the CPU 21 has determined that the particle number (N1) of the overlap region in the first classification data is less than the particle number (N3) of the overlap region in the third classification data (step S1505: YES), the CPU 21 selects the first classification data (step S1506), and the process returns to step S1409.

When the CPU 21 has determined that the particle number (N1) of the overlap region in the first classification data is greater than the particle number (N2) of the overlap region in the second classification data (step S1504: NO), or when the CPU 21 has determined that the particle number (N1) of the overlap region in the first classification data is greater than the particle number (N3) of the overlap region in the third classification data (step S1505: NO), then the CPU 21 determines whether or not the particle number (N2) of the overlap region in the second classification data is less than the particle number (N3) of the overlap region in the third classification data (step S1507).

When the CPU 21 has determined that the particle number (N2) of the overlap region in the second classification data is less than the particle number (N3) of the overlap region in the third classification data (step S1507: YES), the CPU 21 selects the second classification data (step S1502), and the process returns to step S1409. When the CPU 21 has determined that the particle number (N2) of the overlap region in the second classification data is greater than the particle number (N3) of the overlap region in the third classification data (step S1507: NO), the CPU 21 selects the third classification data (step S1508), and the process returns to step S1409.

Note that the method of selecting classification data is not specifically limited, inasmuch as, for example, there is an overlap region in which sampling values are collected for lymphocytes, monocytes, eosinophils, neutrophils, basophils and the like, and the CPU 21 makes a selection based on the occurrence position or the like. Specifically, the selection may be made by (1) selecting via the magnitude of the number of particles contained in the region in which there are overlapping collection regions, (2) selecting via the magnitude of the distance between the representative value of the collection region and the representative value of each presumed region, (3) selecting via the relative position of the collection region and each presumed region, and (4) selecting via combinations such as selecting via the magnitude of the surface area of the collection region and the surface area of each presumed region.

Returning to FIG. 13, the CPU 21 of the operation and display device 2 determines whether or not a reclassification instruction which specifies the execution of the reclassification process has been received from the user (step S1311); when the CPU has determined that the reclassification instruction has been received (step S1311: YES), the CPU 21 receives the selection of other classification data (step S1311), and executes the counting process based on the selected classification data (step S1312).

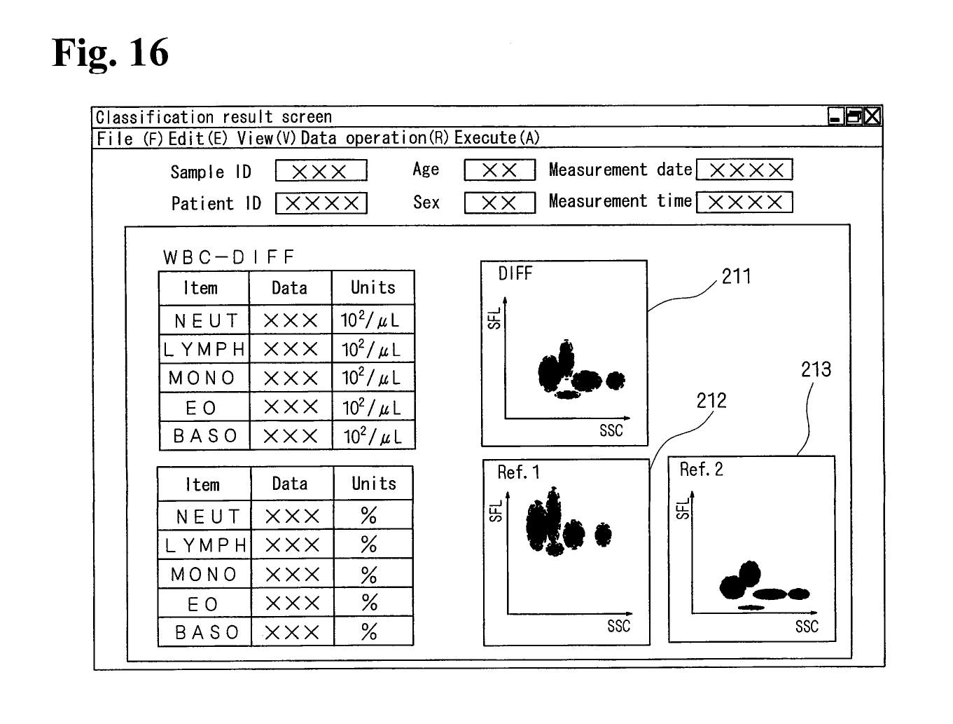

FIG. 16 shows an example of a screen displaying the classification results on the display device 25 of the operation and display device 2 of the second embodiment of the present invention. In FIG. 16, the classification results based on the classification data are displayed in the case of n=3 as in FIG. 14, that is, three types of classification data having mutually different compression ratios are generated. The classification results using the classification data selected by the CPU 21 are displayed in the primary result display region 211, and the classification results using the other classification data are displayed in the secondary result display regions 212 and 213.

The reclassification instruction is issued by using the mouse to select either of the secondary display regions 212 and 213 which display classification results based on classification data which the user wants reclassified. For example, when the secondary display region 212 is selected, the displayed contents of the secondary display region 212 and the primary display region 211 are switched, and the counting process is executed.

Returning to FIG. 13, the CPU 21 of the operation and display device 2 determines whether or not a shutdown instruction has been received (step S1 313); when the CPU 21 has determined that a shutdown instruction has not been received (step S1313: NO), the CPU 21 returns the process to step S1303, and the previously described process is repeated. When the CPU 21 has determined that a shutdown instruction has been received (step S1313: YES), the CPU 21 transmits shutdown instruction information to the measuring device 1 (step S1314).

The controller 91 of the measuring device 1 determines whether or not shutdown instruction information has been received (step S1322); when the controller 91 has determined that shutdown instruction information has not been received (step S1322: NO), the controller 91 returns the process to step S1316 and the previously described process is repeated. When the controller 91 has determined that shutdown instruction information has been received (step S1322: YES), the controller 91 executes shutdown (step S1323) and the process ends.

The second embodiment is capable of executing the counting process using optimum classification data and thus improves the accuracy of sample analysis even in the case of differences such as different animal species, different ages and different sex, by pre-generating a plurality of classification data having mutually different compression ratios and selecting optimum classification data according to the sample.

In the first and second embodiments, the operation processing load of the device is reduced because integer sequence information is used as classification data and measurement data obtained from the measuring device 1.

Note that although a blood analyzer which analyzes blood cells contained in blood sample is described by way of example in the above first and second embodiment, the present invention is not limited to this example inasmuch as the same effect may be expected when the present invention is applied to a sample analyzer which analyzes samples which contain biological particles such as cells in urine. Although the analysis results are displayed by the display device 25 of the operation and display device 2 in the first and second embodiments described above, the present invention is not specifically limited to this example inasmuch as the results may also be displayed on a display device of another computer connected to a network.

Although a plurality of classification data are generated by obtaining 12-bit integer sequence information as measurement data from the measuring device 1 and compressing the 12-bit integer sequence information to 8-bit integer sequence information in the first and second embodiments described above, the present invention is not limited to this arrangement inasmuch as, for example, 16-bit integer sequence information may be obtained from the measuring device 1 to generate 10-bit compression data. The measurement data and classification data need not be integer sequence information.

In the first embodiment, 12-bit integer sequence information obtained from the measuring device 1 is directly compressed to 8-bit integer sequence information when generating a first classification data for adult blood, and 12-bit integer sequence information is multiplied by 1.2 times then the integer part is compressed to 80-bit integer sequence information when generating a second classification data for child blood; however, the present invention is not limited to this arrangement inasmuch as 8-bit integer sequence information obtained from the measuring device 1 may be directly used when obtaining 8-bit integer sequence information as measurement data from the measuring device 1 and performing a process to classify the blood cells in adult blood, and the 8-bit integer sequence information obtained from the measuring device 1 may be multiplied 1.2 times to obtain integer sequence information to be used when performing a process to classify blood cells in child blood. In this case, child blood classification data may also be generated before the user issues a reanalysis instruction based on child blood, and child blood classification data may also be generated at the moment the instruction is issued without generating the child blood classification data until the user issues an instruction.

In the first and second embodiments are also applicable when analyzing blood which contains, for example, megakaryocytes since the blood cell classification process is conducted based on a plurality of generated classification data. Since a megakaryocyte is cell which has a large nucleus, the megakaryocyte is characteristically easily stainable. Therefore, blood containing megakaryocytes can be measured by flow cytometry and a two-dimensional scattergram can be prepared which has side fluorescent light as a single parameter, and there may be cases when megakaryocytes cannot be classified readily from the cells in the blood since the megakaryocytes collect in the upper level position of the scattergram. In this case, for example, a third classification data can be generated which has integer sequence information which is more compressed than the first classification information to be used as classification data when classifying the megakaryocytes. When a scattergram such as that shown in FIG. 7 is prepared based on generated third classification data, the megakaryocytes which collect at the upper level position of the scattergram are shifted downward to a position in a region suited for classifying megakaryocytes. Thus, megakaryocytes can be well classified by conducting a classification process based on the generated third classification data.

In the first and second embodiments, the CPU 21 of the operation and display device 2 executes processes of generating the first and second classification data, the leukocyte classification process, and counting process, however, the present invention is not limited to this arrangement. The above processes may be executed by the controller 91 of the measuring device 1.

What is claimed is:

1. A sample analyzer for analyzing a sample containing a plurality of kinds of particles, comprising:
a quantization information obtainer for obtaining quantization information representing characteristics of the particles in the sample;
first generating means for generating first classification data for classifying the particles in the sample into a plurality of kinds of particles, from the quantization information obtained by the quantization information obtainer;
second generating means for generating second classification data for classifying the particles in the sample into a plurality of kinds of particles, from the quantization information obtained by the quantization information obtainer, the second classification data being different from the first classification data;
a memory for storing a classification condition to be used for classifying the particles in the sample into a plurality of kinds of particles; and
classifying means for classifying the particles in the sample into a plurality of kinds of particles, based on the classification condition and one of the first classification data and the second classification data.

2. The sample analyzer of claim 1, wherein
number of bits of the first classification data and number of bits of the second classification data are the same, and the number of bits of the first classification data and the second classification data are less than number of bits of the quantization information obtained by the quantization information obtainer.

3. The sample analyzer of claim 2, wherein
the first generating means generates the first classification data by converting the quantization information obtained by the quantization information obtainer to data of a predetermined number of bits; and
the second generating means generates the second classification data by converting to data of the predetermined number of bits after expanding or compressing the quantization information obtained by the quantization information obtainer by a predetermined scale factor.

4. The sample analyzer of claim 3, wherein
the sample is a blood;
the second generating means generates the second classification data by converting to data of the predetermined number of bits after expanding the quantization information obtained by the quantization information obtainer by the predetermined scale factor; and
the classifying means classifies the particles in the sample based on the classification condition and the first classification data when the sample is an adult blood, and classifies the particles in the sample based on the classification condition and the second classification data when the sample is a child blood.

5. The sample analyzer of claim 1, wherein
the first generating means generates the first classification data and the second generating means generates the second classification data when the quantization information obtainer has obtained the quantization information;
the sample analyzer further comprises classification instruction receiving means for receiving instruction for executing classification of the particles in the sample based on the second classification data; and
the classifying means classifies the particles in the sample based on the classification condition and the first classification data when the first classification data have been generated, and classifies the particles in the sample based on the classification condition and the second classification data when the classification instruction receiving means has received the instruction.

6. The sample analyzer of claim 1, wherein
the first generating means generates the first classification data when the quantization information obtainer has obtained the quantization information;
the classifying means classifies the particles in the sample based on the classification condition and the first classification data when the first classification data have been generated;
the sample analyzer further comprises classification instruction receiving means for receiving instruction for executing classification of the particles in the sample based on the second classification data;
the second generating means generates the second classification data when the classification instruction receiving means has received the instruction; and
the classifying means classifies the particles in the sample based on the classification condition and the second classification data when the second classification data have been generated.

7. The sample analyzer of claim 1, further comprising:
distribution diagram preparing means for preparing distribution diagram data for showing a distribution diagram representing a state of distribution of the particles in the sample, based on one of the first classification data and the second classification data;
a display part; and
display controlling means for controlling the display part so as to display the distribution diagram based on the distribution diagram data prepared by the distribution diagram preparing means.

8. The sample analyzer of claim 1, wherein
the first generating means generates the first classification data and the second generating means generates the second classification data when the quantization information obtainer has obtained the quantization information; and
the classifying means obtains a first classification result based on the classification condition and the first classification data when the first classification data have been generated, and obtains a second classification result based on the classification condition and the second classification data when the second classification data have been generated.

9. The sample analyzer of claim 1, wherein
the quantization information obtainer obtains first quantization information and second quantization information as the quantization information; and
the first classification data and the second classification data are two-dimensional classification data based on the first quantization information and the second quantization information.

10. The sample analyzer of claim 9, wherein
the first quantization information is information related to a fluorescent light intensity obtained from the sample irradiated by light; and
the second quantization information is information related to a scattered light intensity obtained from the sample irradiated by light.

11. The sample analyzer of claim 1, wherein
the quantization information, the first classification data, and the second classification data are integer sequence information.

12. A sample analyzer for analyzing a sample containing a plurality of kinds of particles, comprising:
first quantization information obtaining means for obtaining first quantization information representing characteristics of the particles in the sample, the first quantization information being quantized to a predetermined number of bits;
second quantization information obtaining means for obtaining second quantization information by expanding or compressing the first quantization information obtained by the first quantization information obtaining means by a predetermined scale factor, the second quantization information being quantized to the predetermined number of bits;
a memory for storing a classification condition to be used for classifying the particles in the sample into a plurality of kinds of particles; and
classifying means for classifying the particles in the sample into a plurality of kinds of particles based on the classification condition and one of the first quantization information and the second quantization information.

13. The sample analyzer of claim 12, wherein
the second quantization information obtaining means obtains the second quantization information when the first quantization information obtaining means obtains the first quantization information;
the sample analyzer further comprises classification instruction receiving means for receiving instruction for executing classification of the particles in the sample based on the second quantization information; and
the classifying means classifies the particles in the sample based on the classification condition and the first quantization information when the first quantization information has been obtained, and classifies the particles in the sample based on the classification condition and the second quantization information when the classification instruction receiving means has received the instruction.

14. The sample analyzer of claim 12, wherein
the classifying means classifies the particles in the sample based on the classification condition and the first quantization information when the first quantization information has been obtained;
the sample analyzer further comprises classification instruction receiving means for receiving instruction for executing classification of the particles in the sample based on the second quantization information;
the second quantization information obtaining means obtains the second quantization information when the classification instruction receiving means has received the instruction; and
the classifying means classifies the particles in the sample based on the classification condition and the second quantization information when the second quantization information has been obtained.

15. The sample analyzer of claim 12, further comprising:
distribution diagram preparing means for preparing a distribution diagram data for showing a distribution diagram representing a state of distribution of the particles in the sample based on one of the first quantization information and second quantization information;
a display part; and
display controlling means for controlling the display part so as to display the distribution diagram based on the distribution diagram data prepared by the distribution diagram preparing means.

16. The sample analyzer of claim 12, wherein
the second quantization information obtaining means obtains the second quantization information when the first quantization information obtaining means has obtained the first quantization information; and
the classifying means obtains a first classification result based on the classification condition and the first quantization information when the first quantization information has been obtained, and obtains a second classification result based on the classification condition and the second quantization information when the second quantization information has been obtained.

17. The sample analyzer of claim 12, wherein
each of the first quantization information and the second quantization information is two-dimensional information including information relating to fluorescent light intensity obtained from the sample irradiated by light and information relating to scattered light intensity obtained from the sample irradiated by light.

18. The sample analyzer of claim 12, wherein
the sample is a blood;
the second quantization information obtaining means obtains the second quantization information by expanding the first quantization information by the predetermined scale factor;
the classifying means classifies the particles in the sample based on the classification condition and the first quantization information when the sample is an adult blood, and classifies the particles in the sample based on the classification condition and the second quantization information when the sample is a child blood.

19. The sample analyzer of claim 12, wherein
the first quantization information and the second quantization information are integer sequence information.

20. A computer program product for enabling a computer to control a sample analyzer for analyzing a sample containing a plurality of kinds of particles, comprising:
a computer readable medium,
a classification condition, on the computer readable medium, to be used for classifying the particles in the sample into a plurality of kinds of particles, and
software instructions, on the computer readable medium, for enabling the computer to perform predetermined operations comprising:
controlling the sample analyzer so as to obtain quantization information representing characteristics of the particles in the sample;
generating first classification data for classifying the particles in the sample into a plurality of kinds of particles, from the obtained quantization information;
generating second classification data for classifying the particles in the sample into a plurality of kinds of particles, from the obtained quantization information, the second classification data being different from the first classification data; and
classifying the particles in the sample into a plurality of kinds of particles, based on the classification condition and one of the first classification data and the second classification data.
